(19) United States
(12) Patent Application Publication
(10) Pub. No.: US 2012/0123778 A1
(43) Pub. Date: May 17, 2012

(54) Security Control for SMS and MMS Support Using Unified Messaging System

(75) Inventors: Mehrad Yasrebi, Austin, TX (US); James Jackson, Austin, TX (US); Cheryl Lockett, Austin, TX (US)

(73) Assignee: AT&T INTELLECTUAL PROPERTY I, L.P., Reno, NV (US)

(21) Appl. No.: 12/944,225

(22) Filed: Nov. 11, 2010

(51) Int. Cl. G10L 15/26; H04M 1/66

(52) U.S. Cl. 704/235; 455/410; 704/E15.043

(57) ABSTRACT

A method and apparatus for providing security control of short messaging service (SMS) messages and multimedia messaging service (MMS) messages in a unified messaging (UM) system are disclosed. An SMS or MMS message directed to a recipient mailbox in a UM system is received. It is determined that the recipient mailbox is a secondary mailbox associated with a primary mailbox in the UM system. The message is audited according to an audit policy associated with the recipient mailbox.

### BACKGROUND

The disclosed technology relates generally to unified messaging and more particularly to security control for short messaging service (SMS) and multimedia messaging service (MMS) support in a unified messaging system.

Unified messaging is the integration of different forms of communication (e.g., email, voicemail, fax, etc.) into a single, unified message store (e.g., a Unified Messaging system) accessible from a variety of user devices. Unified messaging is typically provided by a service provider, which may be the same service provider that provides telephone service. Each user or subscriber of a unified messaging service is typically assigned his/her own unified messaging mailbox, which stores various types of messages for the user. A user can typically access his/her mailbox via various networks (e.g., packet, telephone, etc.) to retrieve messages.

### BRIEF SUMMARY

The present disclosure provides a method and system for security control for short messaging service (SMS) and multimedia messaging service (MMS) support in a unified messaging (UM) system.

In one embodiment, a message directed to a recipient mailbox in a unified messaging system is received. The message is delivered to the unified messaging system through a short messaging service or a multimedia messaging service. It is determined that the recipient mailbox is a secondary mailbox associated with a primary mailbox in the unified messaging system and the message is audited according to an audit policy associated with the recipient mailbox. Text and meta-data of the message can be automatically analyzed to determine if the message is suspect. If the message is determined to be suspect, the message can be forwarded to a quarantine folder of the primary mailbox. If the message is determined not to be suspect, the message can be forwarded to the recipient mailbox.

These and other advantages of the invention will be apparent to those of ordinary skill in the art by reference to the following detailed description and the accompanying drawings.

### BRIEF DESCRIPTION OF THE DRAWINGS

FIG. 1 illustrates a Unified Messaging system providing network-based SMS services according to an embodiment of the present disclosure;

FIG. 2 illustrates a unified messaging (UM) system according to an embodiment of the present disclosure;

FIG. 3 is a flowchart of a method 300 of providing security control for SMS and MMS messages in a unified messaging system according to am embodiment of the present disclosure; and

FIG. 4 is a high-level block diagram of a computer capable of implementing the embodiments of the present invention.

### DETAILED DESCRIPTION

The present disclosure relates to providing support for short messaging service (SMS) and multimedia messaging service (MMS) messages in a unified messaging system. Unified messaging is the integration of different forms of communication (e.g., email, voicemail, fax, etc.) into a single, UM system accessible from a variety of user devices. According to various embodiments of the present disclosure, SMS and MMS can be added as additional message types in a Unified Messaging system. In order to support SMS and MMS messages in a Unified Messaging system, embodiments of the present disclosure provide methods and systems for a Unified Messaging system to provide security control and services for network-based SMS and MMS realizations in both consumer and business environments. Further, embodiments of the present invention provide security-related services for SMS and MMS in a Unified Messaging system such as parental controls, business use policies, audits of message contents, quarantine storage and release services, and related contact management services.

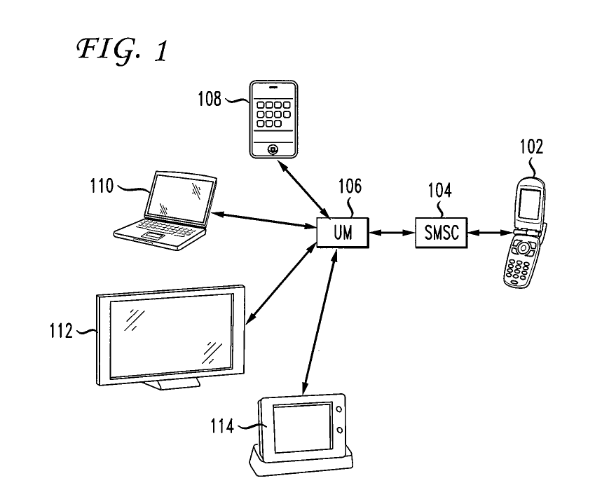

FIG. 1 illustrates a Unified Messaging system providing network-based SMS services according to an embodiment of the present disclosure. As illustrated in FIG. 1, a sender sends an SMS message directed to a recipient from a sending device 102, such as a mobile phone. In addition to routing the SMS message to the target mobile phone of the recipient, a short messaging service center 104 also routes the SMS message to a UM system 106, of which the intended recipient is a subscriber. The UM system 106 stores the SMS message in a mailbox associated with the recipient. The recipient may then access the UM system 106 to retrieve the stored SMS message via a network using any of various devices, such as phone 108, computer 110, television 112, and home manager 114. The devices 108, 110, 112, and 114 may access the UM system 106 over any type of network, such as a packet-based network (e.g., the Internet), a cellular network, a telephone network, etc. The sending device 102 may also be computer, television set-top box, a mobile device or other devices.

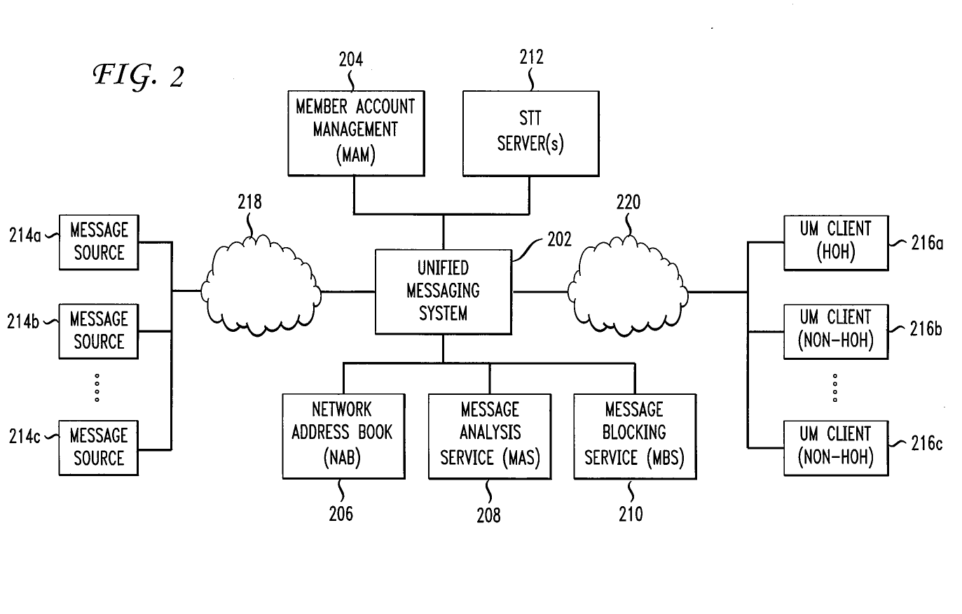

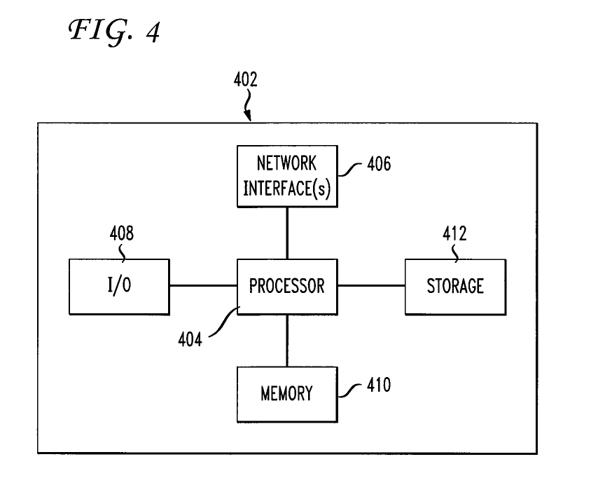

FIG. 2 illustrates a unified messaging (UM) system according to an embodiment of the present disclosure. As illustrated in FIG. 2, UM system 202 provides unified messaging services for various users. UM system 202 includes mailboxes for the users and can electronically store various types of messages in each mailbox, including SMS and MMS messages. UM system 202 may include a processor (not shown) to control operations UM system 202. UM system 202 may include one or more interfaces (not shown) configured to enable communication between UM system 202 and various users. In particular, the interface(s) of UM system 202 allows users to access UM system 202 via various telephone, data packet, cellular, etc., networks (such as networks 218 and 220) using various types of devices. It is to be understood that networks 218 and 220 can represent any type of communication network including but not limited to telephone, packet, cellular, etc. Further, networks 218 and 220 can include or attach to other networks and can be implemented using any technology, such as wireless, the Internet, wired, etc., or any combination thereof. UM system 202 may also include a database (not shown) configured to store the messages in each mailbox. It is to be understood that the UM system 202 may be implemented on a computer or distributed over multiple computers, as described in greater detail below with reference to FIG. 4.

Blocks 204, 206, 208, 210 and 212 depict various services that can be implemented by UM system 202 or be implemented separately. The services of blocks 204, 206, 208, 210 and 212 may be implemented using one or more computers connected to each other or distributed over one or more networks. Although FIG. 2 shows connections between blocks 204, 206, 208, and 210, 212 an UM system 202, one skilled in the art would understand that these connections can represent wired or wireless connections or communications via one or more networks. Member account management (MAM) 204 stores various information related to member accounts. In particular, an MAM database stores relationship information relating to relationships (if any) between various users in an organization. An organization can refer to a business, family, or any other type of organization. The MAM database stores relationships between primary and secondary accounts. In a group or family of account holder, a primary account holder is in an authoritative position with respect to one or more secondary account holders. For example, in a family a parent may have a primary account and children may have secondary accounts associated with the primary account. Similarly, in a business organization a manager may have a primary account and employees working under the manager may have secondary accounts. The member MAM database may store relationship information having multiple hierarchical layers. Accordingly, a primary account with respect to one group of accounts may also be a secondary account with respect to another group of accounts. For example, a primary account of a supervisor that is associated with secondary accounts of various employees may also be considered a secondary account associated with a higher level manager to whom the supervisor reports. A primary account for a particular group is also referred to herein as a “head of household” or “HOH” account. It is to be understood that the term “HOH” is not limited to a family, but also may be applied to businesses and other organizations. In a business or other organization, the HOH may be a supervisor or another person who may manage some subscribers of the UM system 202 or be authorized to monitor emails and/or other messages of some subscribers of the UM system 202.

Network address book (NAB) 206 globally address books for UM users/clients. For example, for each user, an NAB database can store an address book containing contact information. The NAB can maintain the address book for a particular user on multiple devices associated with the user.

Message analysis service (MAS) 208 is a text analysis engine that can be used to analyze text in or associated with messages. In one or more embodiments, MAS 208 can analyze text and meta-data of the message. As used herein, “meta-data” refers to any text associated with a message, but not necessarily part of the content of the message itself. Examples of meta-data can include, but are not limited to, sender information, the date the message was sent, a subject line of the message, a message type, etc. For example, MAS 208 can analyze text in incoming email, SMS, or transcribed portion of MMS messages to search for particular words or terms, such as forbidden words. According to a possible implementation, MAS 208 can maintain a database of forbidden words and phrases and compare text in incoming messages with the words stored and phrases. The audio portions of non-text messages such as MMS messages can be transcribed for the UM system 202 by the STT Server(s) 212.

Message Blocking Service (MBS) 210 blocks messages received at the UM system 202 from particular sources. For example, MBS 210 may maintain a database of forbidden sources and block messages received from the forbidden sources. Example implementations of Message Blocking Service 210 include firewall servers.

The UM system 202 may include or communicate with one or more speech-to-text (STT) servers 212. STT server 212 transcribes (converts) speech, for example in audio components of voice-messages and/or MMS messages, to text. In one embodiment, UM system 202 sends audio files, such as voice mail and/or MMS messages, to STT server 212. STT server 212 transcribes the speech in the audio files to corresponding text strings or files and transmits the transcribed text data back to UM system 202, which can then store the converted text in one or more UM mailboxes.

The UM system 202 can receive incoming messages from various message sources 214a-214c via network 218. It is to be understood that network 218 represents any type of communication network or combination of communication networks, and different types of message sources may utilize different communication networks. The messages are directed to an intended recipient 216a-c who is a user/client/subscriber of the UM system 202. The message sources 214a-214c may be any type of source including, but not limited to, computers, mobile telephones, software programs running on various computers, web portals, etc. The messages transmitted to the UM system 202 from message sources 214a-214c may include various types of messages including, but not limited to, email messages, voicemail messages, faxes, web-based messages, SMS messages, MMS messages, etc.

UM clients (users, subscribers) 216a-216c can access the UM system 202 via network 220 to retrieve messages from UM mailboxes stored on the UM system 202. It is to be understood that network 220 represents any type of communication network or combination of communication networks, and the UM clients 216a-216c may access the UM system 202 through various types of networks (e.g., packet, telephone, cellular, etc.) using various types of devices. Each client 216a-216c has a corresponding mailbox stored on UM system 202. When a client 216a-216c connects to the UM system 202, the UM system 202 can authenticate the client 216a-216c and can then provide the user 216a-216c access to the messages stored in the client's mailbox. Note that a client 216a-216c can then retrieve various types of messages, including SMS and MMS messages, over the network used by the client 216a-216c to connect to the UM system 202. As described above, clients within an organization may have a hierarchical relationship. As shown in FIG. 2, client 216a can be an HOH client and clients 216b and 216c can be non-HOH clients that are subordinate to the HOH client 216a. Client 216a may be a subordinate to one or more other clients (not shown) of the UM system 202.

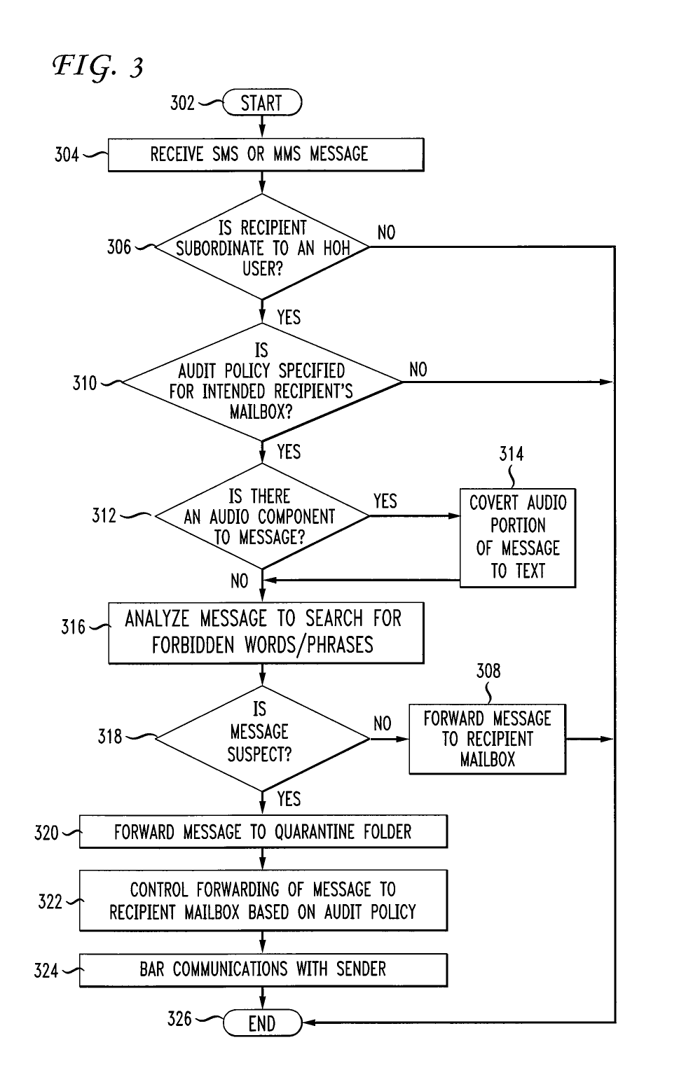

FIG. 3 is a flowchart of a method 300 of providing security control for SMS and MMS messages in a unified messaging system according to am embodiment of the present disclosure. The method 300 may be performed by components of UM system 202 of FIG. 2, as discussed below. The method 300 of FIG. 3 is an exemplary implementation, in which the illustrative features may be rearranged and combined without loss of function, innovation or intent. In the method 300 of FIG. 3, it is assumed that an HOH (e.g., a department manager in a business environment) uses UM system 202 to manipulate the settings of the secondary (e.g., extension) mailboxes of his family members (e.g., his group, in a business class of service (COS) environment), where messages for one or more family members (subordinate employees in a business COS) are stored in such secondary mailboxes. The method begins at 302.

At 304, a message is received by the UM system 202 destined for a mailbox of an intended recipient. The intended recipient is a user/client/subscriber of the UM system 202. According to at least one embodiment, the message is an SMS delivered through a short messaging service or MMS message delivered through a multimedia messaging service.

At 306, it is determined whether the recipient is subordinate user of an HOH user. For example the UM system 202 can query the MAM 204 to retrieve relationship information associated with the intended recipient in order to determine if the recipient is a subordinate user (e.g., a child or employee) associated with at least one HOH user. In a business COS, the hierarchical relationship can be automatically derived by the UM system from a client's an organizational database or can be pre-configured into the UM system 202. If the recipient of the message is determined not to be a subordinate user to any other HOH user, the method proceeds to 308. If the recipient of the message is determined to be a subordinate user to an HOH user, the method proceeds to 310. At 308, if the recipient is not subordinate to any other HOH user, the message is forwarded to the mailbox of the recipient.

At 310, it is determined whether an audit policy has been specified for the mailbox of the recipient. In particular, the HOH (or primary) user associated with the recipient user can specify, in the UM system 202, an audit policy for various message types such as SMS and MMS messages directed to the recipient's mailbox, where the audit policy indicates that the messages should be audited, and specify various settings of the audit policy. In at least one embodiment, the HOH is a user of a primary mailbox, and the intended recipient is a user of a secondary mailbox of that primary mailbox on the UM system 202. If no audit policy is specified for the intended recipient's mailbox, the method proceeds to 308, and the message is forwarded to the mailbox of the recipient. If an audit policy is specified for mailbox of the intended recipient, the method proceeds to 312, and the message is processed based on the audit policy at 312-322.

At 312, it is determined whether there is an audio component to the message. For example, it may be determined whether the message is an MMS message with an audio portion. If the message does have an audio component (e.g. the message is an MMS message with an audio portion), the method proceeds to 314. If the message does not have an audio component (e.g., the message is an SMS message), the method proceeds to 316. At step 314, an audio portion of the message is converted to text. In particular, the UM system 202 can invoke STT server 212 to covert the audio portion of the message to text.

At 316, the message is analyzed to search for forbidden words and phrases. The UM system 202 can invoke MAS 208 to examine the message with respect to meta-data (e.g., sender info, subject line, etc.) and text content of the message. As described above meta-data can refer to any text associated with a message. At 318, it is determined whether the message is suspect. The determination as to whether the message is suspect based on the examination of the message by the MAS 208. In particular, it can be determined that the message is suspect when the MAS 208 detects forbidden words or phrases in the text content or the meta-data of the message. If it is determined that the message is not suspect (i.e., the message contains no forbidden words or phrases), the method proceeds to 308 and the message is forwarded to the mailbox of the recipient. If it is determined that the message is suspect, the method proceeds to 320.

At 320, the message is forwarded to a quarantine folder of the HOH user associated the recipient. When the message is forwarded to the quarantine folder of the HOH user, meta-data can be added to the message to indicate an “in-quarantine” status of the message and to indicate the original recipient information of the message. Further, when the message is forwarded to the quarantine folder of the HOH user, one or more alert notifications (e.g., email, pager message, etc.) may be transmitted to the HOH user to alert the HOH user that a message has been placed in the quarantine folder.

At 322, the forwarding of the message to the original recipient mailbox is controlled based on the audit policy. The audit policy can indicate that the message be forwarded to the recipient's mailbox even when the message is placed under quarantine for review by the HOH user. In this case, the message is forwarded to the recipient's mailbox. The audit policy can indicate that the recipient not receive the message when the message is placed under quarantine. In this case, the message is prevented from being forwarded to the recipient's mailbox. For example, the message may be prevented from being forwarded to the recipient's mailbox until it is reviewed in the quarantine folder by the HOH user. Then, the message may be forwarded to the mailbox of the recipient in response to approval by the HOH user. The audit policy settings indicating whether to forward a suspect message to the mailbox of the recipient can be set by the HOH user.

At 324, communications to and/or from the sender of the suspect message may be barred. The sender may be barred temporarily or permanently. For example, the UM system 202 may interact with MBS 210 to temporarily bar communications to and from that sender. When a message forbidden content is detected in a message, the UM system 202 can automatically add the sender information for the sender of the message to the database of forbidden sources in the MBS 210. Accordingly, the MBS 210 will then block future communications with that sender.

The method 300 ends at 326.

The method 300 of FIG. 3 illustrates processing a message based on an audit policy. It is to be understood that the method 300 of FIG. 3 illustrates one embodiment and various settings of the audit policy may change how a message is processed in the UM system 202. The UM system 202 may provide an interface that allows a primary mailbox user (HOH user) to specify various audit policy settings for zero or more secondary (subordinate) mailboxes associated with the primary mailbox. For example, the primary (HOH) user may specify auditing services for one or more devices on any subordinate secondary mailbox. The primary user may specify and manipulate a list of key-words that are used to identify suspect messages. The primary user may alter the auditing parameters and constraints for each of the secondary mailbox and devices (audit properties of a mailbox could apply to all of the devices associated with that mailbox, in an exemplary implementation).

The primary user also may specify whether the UM system should automatically forward each message, even though when a message is marked as suspect and copied into a quarantine folder. If the message forwarded to the recipient mailbox even when the message is marked as suspect and copied into a quarantine folder, the message auditing procedure can be performed in a “hidden” or inconspicuous fashion without the originally intended recipient's knowledge. The primary user can view and remove messages from the quarantine folder. The primary user can remove the message from the quarantine folder and forward the message to the original recipient's mailbox as if no constraints were placed on the message (if the auditing procedure is not configured to operate in the “hidden” fashion for that mailbox/device). The primary user may also delete the message from the quarantine folder. The primary user may also interrupt further transmission of the message, if not operating in a “hidden” fashion for that device/mailbox. The primary user can confirm or reject placements of the senders in the MBS list. The primary user can also specify forwarding of suspect messages to one or more destinations, such as the primary user's own mobile device.

The various components of FIG. 2 and above described methods for providing security control for SMS and MMS messages in a UM system 202 can be implemented on a computer using well-known computer processors, memory units, storage devices, computer software, and other components. A high-level block diagram of such a computer is illustrated in FIG. 4. Computer 402 contains a processor 404 which controls the overall operation of the computer 402 by executing computer program instructions which define such operation. The computer program instructions may be stored in a storage device 412, or other computer readable medium (e.g., magnetic disk, CD ROM, etc.), and loaded into memory 410 when execution of the computer program instructions is desired. Thus, the method steps of FIG. 3 can be defined by the computer program instructions stored in the memory 410 and/or storage 412 and controlled by the processor 404 executing the computer program instructions. For example, the computer program instructions can be implemented as computer executable code programmed by one skilled in the art to perform an algorithm defined by the method steps of FIG. 3. Accordingly, by executing the computer program instructions, the processor 404 executes an algorithm defined by the method steps of FIG. 3. The computer 402 also includes one or more network interfaces 406 for communicating with other devices via a network. The computer 402 also includes input/output devices 408 that enable user interaction with the computer 402 (e.g., display, keyboard, mouse, speakers, buttons, etc.) One skilled in the art will recognize that an implementation of an actual computer could contain other components as well, and that FIG. 4 is a high level representation of some of the components of such a computer for illustrative purposes. Various components of FIG. 2 can be combined, rearranged, geographically co-located, and/or geographically dispersed.

The foregoing Detailed Description is to be understood as being in every respect illustrative and exemplary, but not restrictive, and the scope of the general inventive concept disclosed herein is not to be determined from the Detailed Description, but rather from the claims as interpreted according to the full breadth permitted by the patent laws. It is to be understood that the embodiments shown and described herein are only illustrative of the principles of the present general inventive concept and that various modifications may be implemented by those skilled in the art without departing from the scope and spirit of the general inventive concept. Those skilled in the art could implement various other feature combinations without departing from the scope and spirit of the general inventive concept.

1. A method for providing security control for messages received in a unified messaging system through a short messaging service and a multimedia messaging service, the method comprising;
receiving a message directed to a recipient mailbox in the unified messaging system;
determining that the recipient mailbox is a secondary mailbox associated with a primary mailbox in the unified messaging system; and
auditing the message according to an audit policy associated with the recipient mailbox.

2. The method of claim 1, wherein the audit policy associated with the recipient mailbox is set by a user associated with the primary mailbox.

3. The method of claim 1, wherein auditing the message according to an audit policy associated with the recipient mailbox comprises:
automatically analyzing text and meta-data of the message to determine if the message is suspect.

4. The method of claim 3, wherein the message is a multimedia message delivered through the multimedia messaging service and auditing the message according to an audit policy associated with the recipient further comprises:
converting an audio portion of the message to text using a speech-to-text server.

5. The method of claim 3, wherein auditing the message according to an audit policy associated with the recipient further comprises:
if the message is determined not to be suspect, forwarding the message to the recipient mailbox; and
if the message is determined to be suspect, forwarding the message to a quarantine folder of the primary mailbox.

6. The method of claim 5, wherein auditing the message according to an audit policy associated with the recipient further comprises:
if the message is determined to be suspect, forwarding the message to the recipient mailbox in addition to the quarantine folder of the primary mailbox.

7. The method of claim 5, wherein auditing the message according to an audit policy associated with the recipient further comprises:
if the message is determined to be suspect, preventing the message from being forwarded to the recipient mailbox.

8. The method of claim 5, wherein auditing the message according to an audit policy associated with the recipient further comprises:
in response to forwarding the message to the quarantine folder, adding meta-data to the message to indicate a quarantine status of the message and to indicate original recipient information of the message.

9. The method of claim 3, wherein auditing the message according to an audit policy associated with the recipient further comprises:
if the message is determined to be suspect, barring communications with a sender of the message.

10. An apparatus for providing security control for messages received in a unified messaging system through a short messaging service and a multimedia messaging service, the apparatus comprising;
means for receiving a message directed to a recipient mailbox in a unified messaging system;
means for determining that the recipient mailbox is a secondary mailbox associated with a primary mailbox in the unified messaging system; and
means for auditing the message according to an audit policy associated with the recipient mailbox.

11. The apparatus of claim 10, wherein the means for auditing the message according to an audit policy associated with the recipient mailbox comprises:
means for automatically analyzing text and meta-data of the message to determine if the message is suspect.

12. The apparatus of claim 11, the means for auditing the message according to an audit policy associated with the recipient further comprises:
means for converting an audio portion of a multimedia message delivered through the multimedia messaging service to text using a speech-to-text server.

13. The apparatus of claim 11, wherein the means for auditing the message according to an audit policy associated with the recipient further comprises:
means for forwarding the message to the recipient mailbox if the message is determined not to be suspect; and
means for forwarding the message to a quarantine folder of the primary mailbox if the message is determined to be suspect.

14. The apparatus of claim 13, wherein the means for auditing the message according to an audit policy associated with the recipient further comprises:
means for forwarding the message to the recipient mailbox in addition to the quarantine folder of the primary mailbox if the message is determined to be suspect.

15. The apparatus of claim 13, wherein the means for auditing the message according to an audit policy associated with the recipient further comprises: means for preventing the message from being forwarded to the recipient mailbox if the message is determined to be suspect.

16. The apparatus of claim 11, wherein the means for auditing the message according to an audit policy associated with the recipient further comprises:
means for barring communications with a sender of the message if the message is determined to be suspect.

17. A non-transitory computer readable medium encoded with computer executable instructions for providing security control for messages received in a unified messaging system through a short messaging service and a multimedia messaging service, the computer executable instructions defining:
receiving a message directed to a recipient mailbox in a unified messaging system;
determining that the recipient mailbox is a secondary mailbox associated with a primary mailbox in the unified messaging system; and
auditing the message according to an audit policy associated with the recipient mailbox.

18. The computer readable medium of claim 17, wherein the computer executable instructions defining auditing the message according to an audit policy associated with the recipient mailbox comprise computer executable instructions defining:
automatically analyzing text and meta-data of the message to determine if the message is suspect.

19. The computer readable medium of claim 18, wherein the message is a multimedia message delivered through the multimedia messaging service and the computer executable instructions defining auditing the message according to an audit policy associated with the recipient further comprise computer executable instructions defining:
converting an audio portion of the message to text using a speech-to-text server.

20. The computer readable medium of claim 18, wherein the computer executable instructions defining auditing the message according to an audit policy associated with the recipient further comprise computer executable instructions defining:
if the message is determined not to be suspect, forwarding the message to the recipient mailbox; and
if the message is determined to be suspect, forwarding the message to a quarantine folder of the primary mailbox.

21. The computer readable medium of claim 20, wherein the computer executable instructions defining auditing the message according to an audit policy associated with the recipient further comprise computer executable instructions defining:
if the message is determined to be suspect, forwarding the message to the recipient mailbox in addition to the quarantine folder of the primary mailbox.

22. The computer readable medium of claim 20, wherein the computer executable instructions defining auditing the message according to an audit policy associated with the recipient further comprise computer executable instructions defining:
if the message is determined to be suspect, preventing the message from being forwarded to the recipient mailbox.

23. The computer readable medium of claim 18, wherein the computer executable instructions defining auditing the message according to an audit policy associated with the recipient further comprise computer executable instructions defining:
if the message is determined to be suspect, barring communications with a sender of the message.
